(19) United States
(12) Patent Application Publication
(10) Pub. No.: US 2005/0050114 A1
(43) Pub. Date: Mar. 3, 2005

(54) Method and apparatus for synchronizing data organized by category

(76) Inventor: Timi Soinio, Pirkkala (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/648,777

(22) Filed: Aug. 25, 2003

(51) Int. Cl. G06F 7/00

(52) U.S. Cl. 707/204

(57) ABSTRACT

Method (40) and corresponding equipment (10b) for use by a device (10) in synchronizing a data store (10c) hosted by the device (10) with another data store (11c) hosted by another device (11) or by the same device (10), the method for use in storing data items received from the other data store (11c) even when the other data store (10c) hosted by the device (10) and the other data store (11c) are populated with data items by respective applications (10a 11a) each of which stores data items according to one or another category in respective predetermined sets of categories (10d 11d) but the respective predetermined sets of categories (10d 11d) differ, the method including steps for assigning a category to a new data item during a synchronization session using a predetermined procedure (40 50) for selecting a category from the set of categories (10d) based on an express or implied hierarchies of categories (10d 11d 12 20).

### TECHNICAL FIELD

The present invention pertains to the field of synchronizing data stores. More particularly, the present invention pertains to performing such synchronization when the data stores are populated using different applications (such as different calendar-type applications or different application both of which use calendar-type data, applications which can be hosted by the same or different devices).

### BACKGROUND ART

In case of a device (such as e.g. a mobile phone) that hosts an electronic calendar application, a user can add new data items indicating various calendaring and scheduling entities to a data store hosted by the device and associated with the calendar application. Sometimes such calendar application data stores are synchronized with calendar data stores in other devices operated by the same user. For example, a user may use a mobile phone calendaring application to enter some calendar data items at one time, and later use a desktop computer to enter other calendar data items using perhaps a different calendar application. The user may then want to synchronize the two data stores so that the calendars corresponding to each data store are the same.

In case of e.g. calendar applications, a user is typically allowed to assign a category (i.e. a type) to each data item. For example, a user may add a data item for a certain day indicating that the data item is an anniversary, or, even more specifically, a wedding anniversary as opposed to a birthday or other kind of anniversary. Categorizing data items allows e.g. searching the calendar for all data items of a desired kind (category), or allows the calendar to automatically enter each year some kinds of data items, such as all anniversaries.

A problem arises when trying to synchronize data stores on respective devices when the respective calendar applications on the devices do not support the same categories, i.e. when in entering a new data item a user cannot select a category from the same set of categories on one device as on the other. Thus, e.g. the user may have entered a new data item as a birthday data item on a first device that supports birthday as a lower level category of anniversary, and the user may want to synchronize the data store of the first device with that on a second device where the associated calendar application allows assigning a category of anniversary, but not birthday. Clearly, the data item must be stored in the second device as a data item of category anniversary. But if later the user adds new data items to the second device and wants then to update the first device, the birthday data item, which is stored as an anniversary data item in the second device, appears for the first device to be a different data item than the original birthday data item, and so is possibly entered again into the first device, this time as an anniversary data item (and this time by a synchronizing agent of the first device, not the user).

What is needed is a way to synchronize data stores in case of the data stores having data items with categories (or properties) assigned from different sets of categories, a way that in particular avoids problems in case of synchronizing each data store with respect to the other (first adding all new data items in one to the other, and then vice versa).

### SUMMARY OF THE INVENTION

Accordingly, in a first aspect of the invention, a method is provided for use in synchronizing a first item data store with a second item data store, wherein when storing the items in the first item data store the items are assigned to categories in a first set of categories, and similarly for the second item data store, the method including: a step in which during a synchronization session a new data item already stored in the second data store is selected or received for storing in the first item data store; the method characterized in that: the new data item includes or is accompanied by a category indicator indicating at least two categories in a branch of a hierarchy of categories.

In accord with the first aspect of the invention, the category indicator may indicate all categories in a branch of the hierarchy of categories.

Also in accord with the first aspect of the invention, the first item data store and the second item data store may be hosted by a single device.

Also in accord with the first aspect of the invention, the first item data store and the second item data store may be hosted by respective different devices.

Also in accord with the first aspect of the invention, a synchronization agent may receive or select the new data item, and the method may be further characterized in that: the synchronization agent assigns to the new data item a category from among the first set of categories based on the category indicator and based on a predetermined procedure. Further, the synchronization agent may store the category indicator so as to be associated with the new data item and without changing the category indicator. Also further, the category indicator may be a string of categories beginning with a lowest-level category and leading to a top-level category, or vice versa. Further still, the synchronizing agent may search the first set of categories for a category matching a category in the string of categories, taking each category in the string of categories in turn, beginning with the lowest-level category, and providing as the assigned category the matching category in the first set of categories. Also further still, the category indicator may be a string of categories indicating a possibly partial branch of a harmonized category hierarchy. Still also further still, the data indicating the harmonized category hierarchy may be included as part of the device. Yet still also further still, the harmonized category hierarchy may be stored in a data store external to the device and accessible to the device, and the device may refer to the external data store from time to time so as to remain harmonized to the category hierarchy.

In a second aspect of the invention, an apparatus is provided including at least a first item data store and adapted for synchronizing the first item data store with a second item data store, wherein when storing items in the first item data store the items are assigned to categories in a first set of categories, and wherein for the second item data store items are assigned to categories in a second set of categories, the apparatus including: means by which during a synchronization session a new data item already stored in the second data store is selected or received for storing in the first item data store; the apparatus characterized in that: the new data item includes or is accompanied by a category indicator indicating at least two categories in a branch of a hierarchy of categories.

In accord with the second aspect of the invention, the category indicator may indicate all categories in a branch of the hierarchy of categories.

Also in accord with the second aspect of the invention, the first item data store and the second item data store may both be hosted by the apparatus.

Also in accord with the second aspect of the invention, the first item data store may be hosted by the apparatus but not the second item data store.

Also in accord with the second aspect of the invention, the apparatus may include a synchronization agent and the synchronization agent may receive or select the new data item, and, in addition, the synchronization agent may assign to the new data item a category from among the first set of categories based on the category indicator and based on a predetermined procedure. Further, the synchronization agent may store the category indicator so as to be associated with the new data item and without changing the category indicator. Also further, the category indicator may be a string of categories beginning with a lowest-level category and leading to a top-level category, or vice versa. Further still, the synchronizing agent may search the first set of categories for a category matching a category in the string of categories, taking each category in the string of categories in turn, beginning with the lowest-level category, and providing as the assigned category the matching category in the first set of categories. Also further still, the category indicator may be a string of categories indicating a possibly partial branch of a harmonized category hierarchy. Also further still, data indicating the harmonized category hierarchy may be included as part of the device. Also further still, the harmonized category hierarchy may be stored in a data store external to the device and accessible to the device, and the device may refer to the external data store from time to time so as to remain harmonized to the category hierarchy. Still also further still, the category indicator may a string of categories indicating a possibly partial branch of an express or implied category hierarchy of categories supported by the second device.

Also in accord with the second aspect of the invention, the apparatus is either a mobile cellular phone, a personal digital assistant type of device, a laptop computing device, or a computer.

In a third aspect of the invention, a system is provided, comprising a plurality of devices, characterized in that at least two of the devices are according to the second aspect of the invention.

In a fourth aspect of the invention, a computer program product is provided comprising: a computer readable storage structure embodying computer program code thereon for execution by a computer processor in a telecommunication terminal, with said computer program code characterized in that it includes instructions for performing the steps of a method according to the first aspect of the invention.

### BRIEF DESCRIPTION OF THE DRAWINGS

The above and other objects, features and advantages of the invention will become apparent from a consideration of the subsequent detailed description presented in connection with accompanying drawings, in which:

FIG. 1A is a block diagram/flow diagram of two devices including respective data stores and respective synchronization agents for synchronizing the data stores, and also indicating an optional harmonized category hierarchy (which may or may not be stored in a physical database).

FIG. 1B is a block diagram/flow diagram of a single device including two different data stores and a synchronization agent for synchronizing the data stores, and also indicating an optional harmonized category hierarchy (which may or may not be stored in a physical database).

FIG. 2 is a schematic of a category hierarchy, in general, and as would be represented according to prior art, i.e. it is a traditional schematic of how any hierarchy of things (categories or other things) might be represented.

FIG. 3A is a schematic of a particular example of a possible category hierarchy that may be adopted as a harmonized category hierarchy.

FIG. 3B is a schematic of a particular example of a possible category hierarchy according to which categories (included in a set of categories) supported by one of the devices in FIG. 1 might be organized.

FIG. 4 is an example of a message used in the respective data stores, according to the invention.

FIG. 5 is a flow chart of a method according to the invention.

FIG. 6 is a schematic/block diagram of various devices of the type in which the present invention can be used.

### A MODE FOR CARRYING OUT THE INVENTION

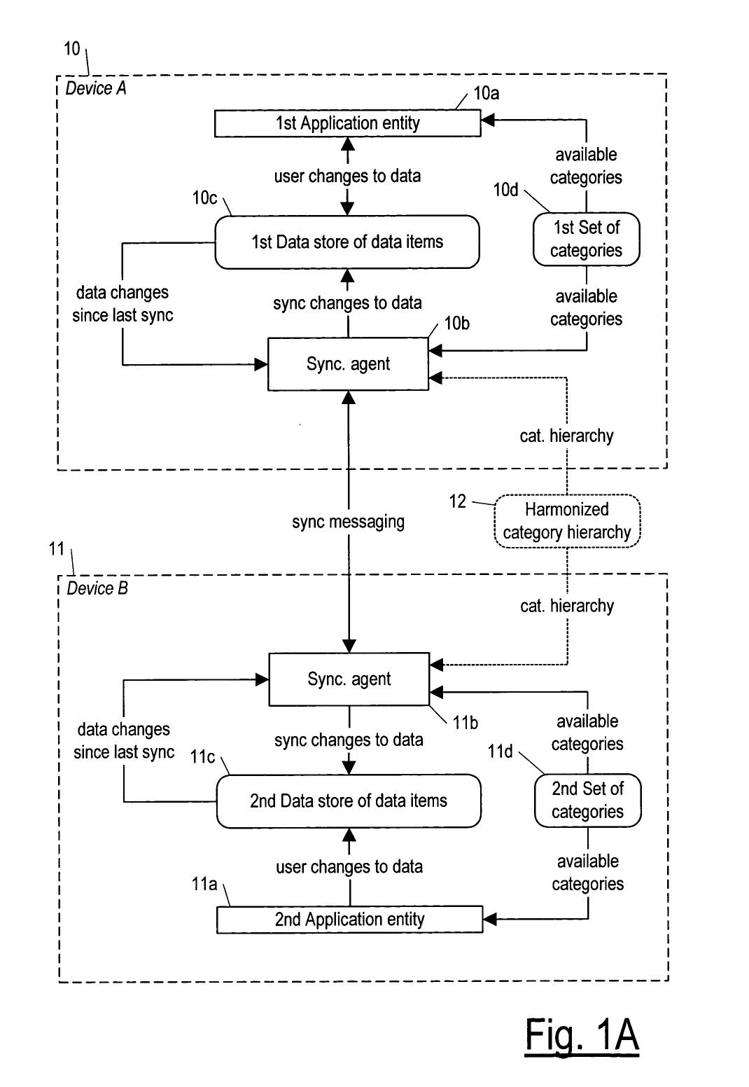

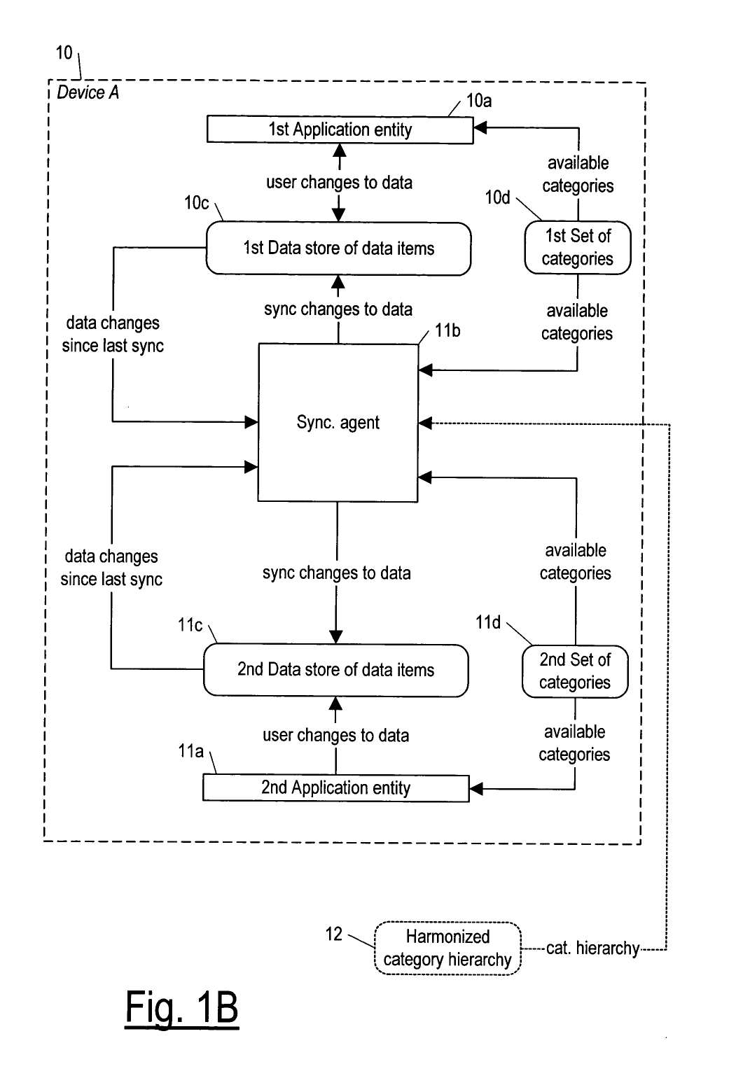

Referring now to FIG. 1A, a device 10 is shown including a data store 10c of data items that is from time to time, during so-called synchronization sessions, synchronized with a corresponding data store 11c of another device 11. For the device 10 to synchronize its data store 10c to the data store 11c of the other device 11, device 10 includes a synchronization agent 10b, and the other device 11 includes a corresponding synchronization agent 11b. The data stores 10c 11c of the two devices 10 11 are populated by data items created (as a result of user interaction) by respective applications 10a 11a hosted by the two devices. Each data item is stored so as to be assigned to a category, with each application 10a 11a using as the assigned category for a data item a category selected from a respective set of categories 10d 11d, which may differ. The sets of categories 10d 11d may or may not be included in data stores within the respective devices 10 11; in some embodiments, the sets of categories can be determined by the synchronization agents 10ba 11b only by querying the applications 10a 11a. The categories in each set of categories 10d 11d may be considered to be arranged according to a hierarchy of categories (such as illustrated in FIG. 2, described below), a hierarchy that may be express (obvious from the user interface of the respective application 10a 11a) or only implied (not so obvious); i.e. each category in either set of categories 10d 11d—except for a general or top-level category—may in general be viewed as a subcategory of another, more general category, so that there are respective hierarchies (not necessarily the same) of categories associated with the two sets of categories 10d 11d.

Each device 10 11 can be any device including a computer processor able to host and execute computer instructions for an application creating (as a result of user interaction) data items having an associated category (which may be included in the data item as e.g. a field in a record or as a so-called property of a data item). For example, the device 10 can be a cellular phone or a laptop or desktop computer, and the application can be an electronic calendar application, such as a calendar application according to the vCalendar 1.0 specification, described e.g. in vCalendar: The Personal Calendaring and Scheduling Exchange Format (a versit Consortium White Paper), published Jan. 1, 1997, on the Internet, available at:
http://www.imc.org/pdi/vcalwhite.html.
   See also RFC 2445, “Internet Calendaring and Scheduling Core Object Specification (iCalendar),” available at:
http://www.ietf.org/rfc/rfc2445.txt.

Referring now to FIG. 2, a category hierarchy 20 is shown as in general including a top-level or first level category 21 (indicated here as C₁), second level categories 22 (indicated here as Cₗᵢ), third level categories 23 (indicated here as Cₗᵢⱼ), and so on. As is apparent, the category hierarchy 20 may be viewed as consisting of a number of entire branches, with the top level as one terminus of each branch and a lowest level category as the other. A partial branch has as one terminus the top level category, and has as the other terminus a category along some entire branch but not the lowest level category of the entire branch.

Referring again to FIG. 1A, when a new data item is added to the data store 11c of the other device 11 by the application 11a of the other device (as a result of user interaction), the new data item must be added to the data store of the device 10 during the next synchronization session, which may involve other entities (not shown), but does involve synchronization messaging between the two devices 10 11, possibly via the other entities; in case of a new data item having been added to the data store 11c of the other device, the synchronization messaging conveys the new data item to the synchronization agent 10b of the device 10. (The category for a data item may be stored as a field value of a record for the data item, or may be stored in a field of a record in a related table.)

Still referring to FIG. 1A, and now assuming that a new data item has been added to the data store 11c of the other device, according to the invention the synchronization agent 11c of the other device 11 conveys to the synchronization agent 10c of the device 10 the new data item along with, or including, a category indicator. According to the invention, the category indicator indicates either a (possibly partial) branch of a harmonized hierarchy of categories 12 or else a (possibly only implied) hierarchy of categories associated with the set of categories 11d of the other device 11; the invention does not require that there be a harmonized hierarchy of categories 12. In embodiments in which there is no harmonized hierarchy of categories, each device may use completely different sets of categories 10d 11d, organized according to completely (and possibly only implied) different hierarchies. In all embodiments of the invention, however, the category indicator corresponds to—or is equivalent to—a string of categories beginning with a first category, assumed to be a lower level or more specific category if the string includes more than one category, and ending with a last category, assumed to be the highest or top or first or most general level category in the hierarchy. Therefore, a category indicator according to the invention is itself or else represents a string of categories of the form:
nth level cat.; (n−1)th level cat.; . . . ; 1st level cat,
   (or other equivalent forms, i.e. using different delimiters such as a comma instead of a semi-colon, and possibly in the reverse order from the order shown) where the nth level category is the category to which the new data item is to be assigned if the application 10a uses such a category, i.e. if it is included in (a usually implied hierarchy of categories consisting of the categories in) the set of categories used by the application 10a, the (n−1)th level category is the first fallback category (to be used only if the application 10a does not use the nth level category), and so on, until, as a last resort, the new data item is assigned to the 1st level category.

Referring still to FIG. 1A, as mentioned, in some embodiments the respective synchronization agents 10b 11b are both adapted to use a single, i.e. harmonized, category hierarchy 12 in providing a category indicator, even though the two devices 10 11 may use different sets of categories 10d 11d. However, in such embodiments, even though the two sets of categories 10d 11d may be different, the two sets of categories 10d 11d in such embodiments can only include categories in the harmonized category hierarchy 12, and the categories included in the respective sets 10d 11d must be hierarchically the same as in the harmonized category hierarchy 12. The harmonized category hierarchy 12 is either implemented as part of the synchronization agents 10b 11b so that knowledge of the harmonized category hierarchy is embedded in the synchronization agents, or is stored in a data store 12 accessible to the synchronization agents, as needed or from time to time. The harmonized category hierarchy would advantageously be provided via a specification document.

In other embodiments, there is no harmonized category hierarchy, and so in providing a category indicator, the respective synchronization agents 10b 11b are adapted to simply provide a string of categories as above, even though the two devices 10 11 may use completely different sets of categories 10d 11d, i.e. even though the two sets of categories 10d 11d may differ either in terms of what categories are included as well as in how the categories are organized into (possibly only implied) respective hierarchies.

It should be understood that the invention applies not only to data stores 10c 11c hosted by different devices, but also in case of both data stores 10c 11c (and respective applications 10a 11a) hosted by the device 10.

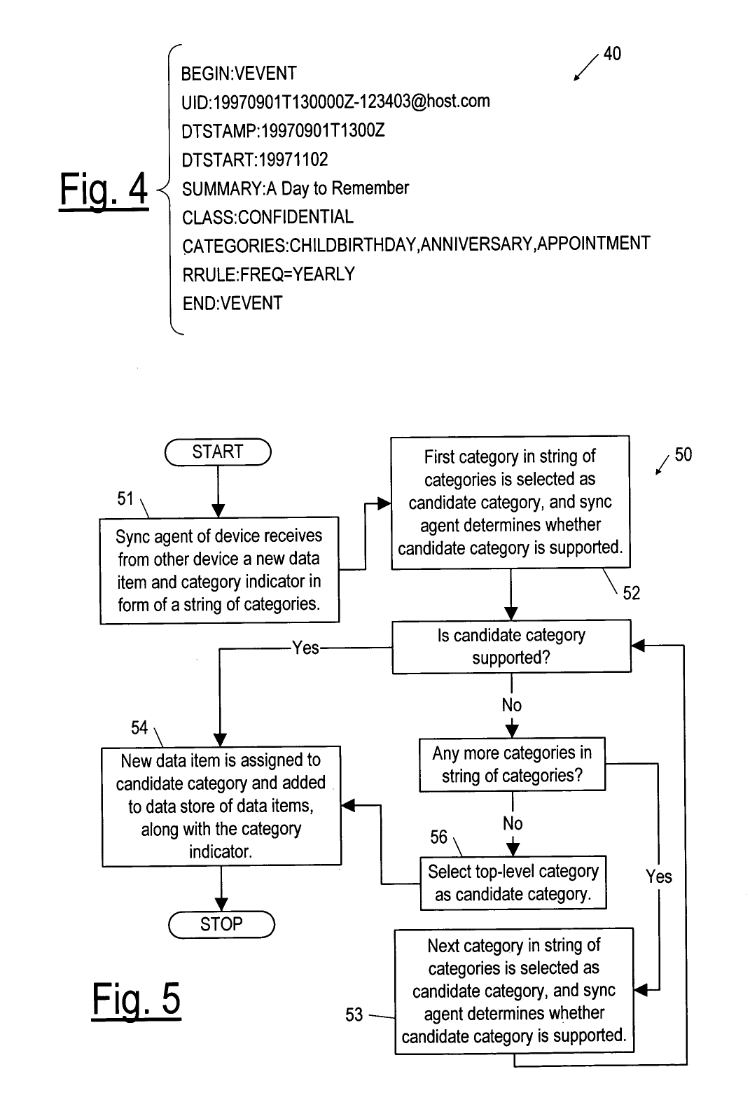

Referring now to FIG. 1B, a device 10 is shown including both a (first item) data store 10c as described in connection with FIG. 1A, and also a second item data store 11c. As in connection with FIG. 1A, the data stores 10c 11c are populated by data items created (as a result of user interaction) by respective applications 10a 11a here both hosted by the device 10. As described above in connection with FIG. 1A, each data item is stored so as to be assigned to a category, with each application 10a 11a using as the assigned category for a data item a category selected from a respective set of categories 10d 11d, which may differ. A single synchronization agent 10b synchronizes the two data stores 10c 11c as described above, i.e. using the category indicator, and, in particular, as set out in the method described below in connection with FIG. 5.

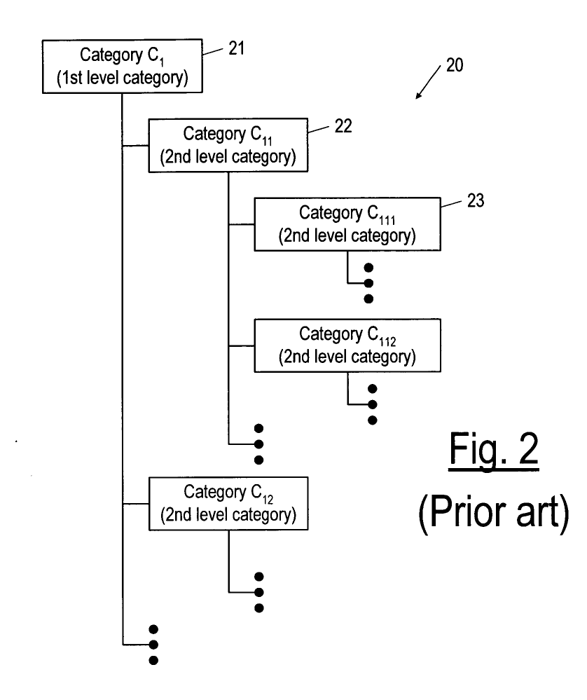

Referring now to FIGS. 3A and 3B, specific examples of two category hierarchies for electronic calendar applications are shown as the same except that the hierarchy in FIG. 3B does not include Birthday as a subcategory of Anniversary, and so the two categories SpouseBirthday and ChildBirthday in FIG. 3B are both subcategories of Anniversary (directly), whereas they are subcategories of Birthday in the hierarchy of FIG. 3A.

Suppose that the category hierarchy represented in FIG. 3A is the harmonized category hierarchy 12 (FIG. 1A), and suppose that the category hierarchy represented in FIG. 3B is the category hierarchy supported in the device 11 (and which is not necessarily the same as the category hierarchy supported in the device 10).

Now in case of embodiments based on the harmonized category hierarchy 12 represented in FIG. 3A, suppose for example that the device 11 adds a child's birthday as a new data item in the category ChildBirthday. In the next synchronization, the device 11 provides to the device 10 not only the new data item, but also the following string of categories as a category indicator:
ChildBirthday; Birthday; Anniversary; Appointment (S1)
   even though the device 11 does not support the category Birthday, since the string of categories (S1) is a (in this case complete, not partial) branch of the harmonized category hierarchy represented in FIG. 3A. The device 10, upon receiving the category indicator (S1), parses it starting with the most specific (lowest-level) category, which is here the left-most category, until it reaches a category it supports, and then assigns the data item to the category it reached. It also saves the category indicator (S1) provided with the data item, and provides the category indicator (S1) with the data item to the device 11 in subsequent synchronizations, as needed (i.e. whenever providing the added data item).

The harmonized category hierarchy 12 may be stored in a data store external to the devices 10 11 (as shown in FIG. 1A) and accessible to the devices 10 11, and the devices 10 11 may then refer to the external data store from time to time so as to remain harmonized to the harmonized category hierarchy 12, i.e. so as to include only categories in the harmonized category hierarchy 12 (but not necessarily all such categories), organized as in the harmonized category hierarchy 12. Alternatively, data indicating the harmonized category hierarchy 12 may be included as part of the devices 10 11.

Now in case of embodiments not based on the harmonized category hierarchy 12 represented in FIG. 3A, suppose again that the device 11 adds a child's birthday as a new data item in the category ChildBirthday. In a future synchronization, the device 11 provides not only the new data item, but also the following string of categories as a category indicator:
ChildBirthday; Anniversary; Appointment (S2)
   since the string of categories (S2) is a (in this case again complete, not partial) branch of the category hierarchy represented in FIG. 3B starting with the category assigned in the device 11 and ending with the top-level category, but including only the categories in the set 11d of categories, and more specifically, in the branch of the hierarchy of categories according to which the categories in the set 11d of categories is organized (either expressly or impliedly). The device 10, upon receiving the category indicator (S2), again parses it starting with the most specific (lowest-level) category, which is here the left-most category, until it reaches a category it supports, and then assigns the data item to the category it reached. If the device 10 does not support any of the categories in the string (S2), then it assigns to the data item the most general category it supports. Also, as in the other embodiment, the device 10 saves the category indicator (S2) provided with the data item, and provides the category indicator (S2) with the data item to the device 11 in subsequent synchronizations, as needed (i.e. whenever providing the added data item). If the device 11 ever receives back the category indicator (S2) it earlier provided to the device 10, it will store the data item in the first category (or at any rate, the lowest-level category) in the category indicator (S2), since by assumption that is a category it supports.

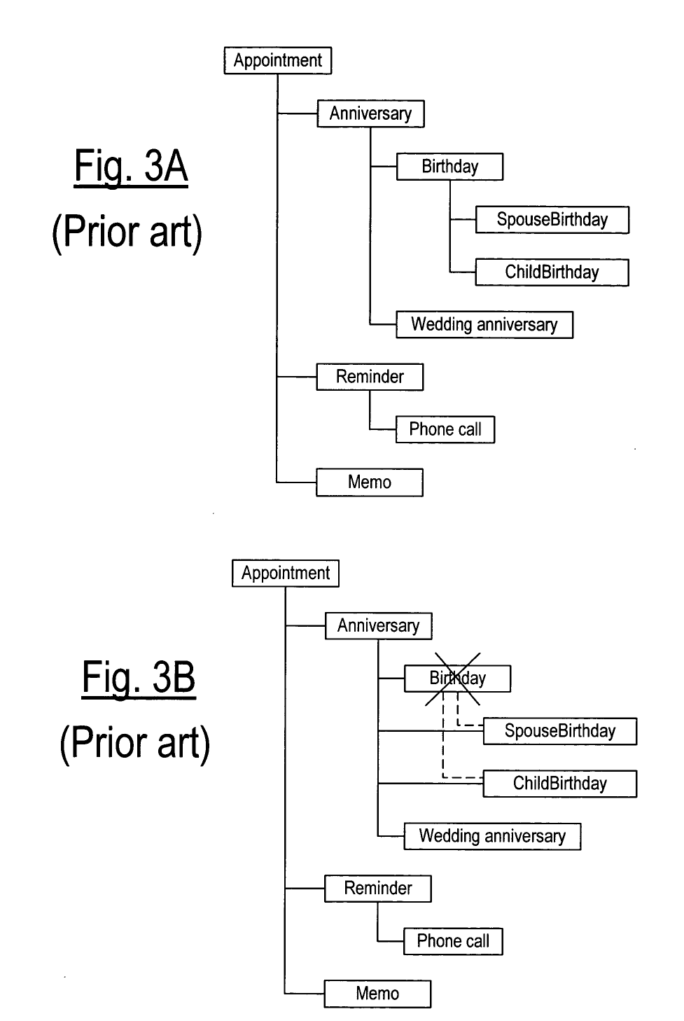

Referring now to FIG. 4, a sample message from device 11 to device 10 communicating a new data item 40 for an iCalendar entry (an iCalendar VEVENT is a “vCalendar 2.0” VEVENT) for an embodiment in which a harmonized hierarchy is not used, and according to the above example of such an embodiment, i.e. after entry of a child's birthday as a new data item in device 11, which is assumed here to support the hierarchy in FIG. 3B.

Thus, whether a harmonized category hierarchy is used or not, the sync agent 10b determines from the category indicator a string of categories indicating first the first most preferred category to assign to the new data item, then the next most preferred, and so on, and selects from the string the most preferred category used by the application 10a, i.e. the most preferred category also occurring in the set of categories 10d, and then stores the new data item so as to have the selected category as an assigned category, and also saves the category indicator, doing so in such a way that the category indicator is associated with the new data item.

Referring now to FIG. 5, a method 50 according to the invention, and applicable in both embodiments in which a harmonized category hierarchy is used as well as in embodiments in which a harmonized category hierarchy is not used, is shown as including a first step 51 in which the sync agent 10b of the device 10 receives from the other device 11 a new data item and an associated category indicator, provided as a string of categories, as shown in FIG. 4 (in the line beginning “Categories:”). In a next step 52, the sync agent 10b selects the first category in the string of categories as a candidate category and determines whether the candidate category is supported. The sync agent 10b can determine whether a category is supported by e.g. asking the application 10a, or by examining the set of categories 10c in embodiments in which there is an actual data store of the set 10d of categories. If the candidate category is not supported, then in a next step 53, the sync agent 10b selects the next category in the string of categories as the candidate category, and determines whether the new candidate category is supported. Once a candidate category is determined to be supported, then in a next step 54, the new data item is assigned by the sync agent 10b to the candidate category and added to the data store 10c of data items (FIG. 1A), along with the category indicator. If no category is determined to be supported (e.g. even the top-level categories differ), then according to the invention, in a step 56 the device 10 handles the event as its own default (top-level) category (e.g. “Appointment”), i.e. it uses as the candidate category its top-level category, and then (in the above described step 54) assigns the new data item to the candidate (top-level) category and stores the data item along with the category indicator unaltered, for subsequent synchronizations.

As indicated above, to find a category to assign to a new data item, the sync agent 10b can search the set of categories 10d starting not with the first category in the string represented by the category indicator, but instead with the last category in the string, and continuing from a current category to the next (lower) level category only if a category is found in the set of categories 10d matching the current category.

As is also apparent from the above description, the invention is of use not only in case of synchronizing data stores of calendar applications on different devices where the data stores have data items assigned to one or another category in an implied hierarchy of categories, but is of use in case of synchronizing data stores of any kind of corresponding applications on different devices where the data stores hold data items with respective properties assigned from an express or implied hierarchy of properties. Thus, the terminology category in the above description is to be understood broadly as indicating any property in an express or implied hierarchy of properties.

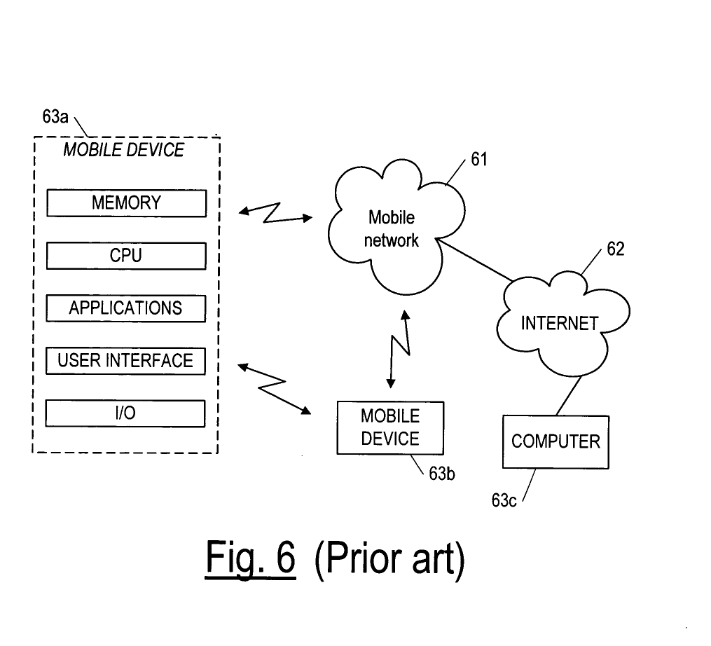

Referring now to FIG. 6, a mobile device 63a of the type in which the present invention can be implemented is shown as including a CPU (central processing unit) that in turn includes volatile memory (not shown) used by the CPU, instructions for use by the CPU in executing various applications including e.g. a calendar application, a non-volatile memory device for holding data used by the applications, i.e. for hosting the data stores used by the applications, (instructions for) a user interface for enabling a user to operate the mobile device, and an I/O (input/output) module for sending and receiving signals used in communicating with other devices. Also shown in FIG. 6 is another mobile device 63b in communication with the first mobile device 63a, either directly (as e.g. in case of Bluetooth-enabled devices) or via a mobile network (such as the so-called Universal Mobile Telecommunication System, which includes one or more varieties of a radio access network). Also shown is a computer 63c in communication with one or more of the mobile devices 63a 63b via (optionally) the Internet 62 and the mobile network 61. (It is of course also possible for the computer 63c to communicate directly with the mobile devices using e.g. Bluetooth technology.)

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

1. A method for use in synchronizing a first item data store (10c) with a second item data store (11c), wherein when storing the items in the first item data store (10c) the items are assigned to categories in a first set of categories (10d), and similarly for the second item data store (11c), the method including:
a step (51) in which during a synchronization session a new data item (40) already stored in the second item data store (11c) is selected or received for storing in the first item data store (10c);
the method characterized in that:
the new data item (40) includes or is accompanied by a category indicator indicating at least two categories in a branch of a hierarchy of categories (11d 12).

2. The method of claim 1, wherein the category indicator indicates all categories in a branch of the hierarchy of categories (11d 12).

3. The method of claim 1, wherein the first item data store (10c) and the second item data store (11c) are hosted by a single device (10).

4. The method of claim 1, wherein the first item data store (10c) and the second item data store (11c) are hosted by respective different devices (10 11).

5. A method as in claim 1, wherein a synchronization agent (10b) receives or selects the new data item (40), and further characterized in that: the synchronization agent (10b) assigns to the new data item (40) a category from among the first set of categories (10d) based on the category indicator and based on a predetermined procedure.

6. A method as in claim 5, further characterized in that: the synchronization agent (10b) stores the category indicator so as to be associated with the new data item (40) and without changing the category indicator.

7. A method as in claim 5, wherein the category indicator is a string of categories beginning with a lowest-level category and leading to a top-level category, or vice versa.

8. A method as in claim 7, further characterized in that the synchronizing agent (10b) searches the first set of categories (10d) for a category matching a category in the string of categories, taking each category in the string of categories in turn, beginning with the lowest-level category, and providing as the assigned category the matching category in the first set of categories (10d).

9. A method as in claim 7, further characterized in that the category indicator is a string of categories indicating a possibly partial branch of a harmonized category hierarchy (12).

10. A method as in claim 9, further characterized in that data indicating the harmonized category hierarchy (12) are included as part of the device (10).

11. A method as in claim 9, further characterized in that the harmonized category hierarchy (12) is stored in a data store (12) external to the device (10) and accessible to the device (10), and the device (10) refers to the external data store (12) from time to time so as to remain harmonized to the category hierarchy (12).

12. A method as in claim 7, further characterized in that the category indicator is a string of categories indicating a possibly partial branch of an express or implied category hierarchy (11d) of categories for organizing items in the second item data store (11c).

13. An apparatus (10) including at least a first item data store (10c) and adapted for synchronizing the first item data store (10c) with a second item data store (11c), wherein when storing items in the first item data store (10c) the items are assigned to categories in a first set of categories (10d), and wherein for the second item data store (11c) items are also assigned to categories in a second set of categories (10d), the apparatus including:
means (51) by which during a synchronization session a new data item (40) already stored in the second data store (11c) is selected or received for storing in the first item data store (10c);
the apparatus characterized in that:
the new data item (40) includes or is accompanied by a category indicator indicating at least two categories in a branch of a hierarchy of categories (11d 12).

14. The apparatus (10) of claim 13, wherein the category indicator indicates all categories in a branch of the hierarchy of categories (11d 12).

15. The apparatus (10) of claim 13, wherein the first item data store (10c) and the second item data store (11c) are both hosted by the apparatus (10).

16. The apparatus (10) of claim 13, wherein the first item data store (10c) is hosted by the apparatus (10) but not the second item data store (11c).

17. The apparatus (10) of claim 13, wherein the apparatus (10) includes a synchronization agent (10b) and wherein the synchronization agent (10b) receives or selects the new data item (40), and further characterized in that: the synchronization agent (10b) assigns to the new data item (40) a category from among the first set of categories (10d) based on the category indicator and based on a predetermined procedure.

18. The apparatus (10) of claim 17, further characterized in that: the synchronization agent (10b) stores the category indicator so as to be associated with the new data item (40) and without changing the category indicator.

19. The apparatus (10) of claim 17, wherein the category indicator is a string of categories beginning with a lowest-level category and leading to a top-level category, or vice versa.

20. The apparatus (10) of claim 19, further characterized in that the synchronizing agent (10b) searches the first set of categories (10d) for a category matching a category in the string of categories, taking each category in the string of categories in turn, beginning with the lowest-level category, and providing as the assigned category the matching category in the first set of categories (10d).

21. The apparatus (10) of claim 19, further characterized in that the category indicator is a string of categories indicating a possibly partial branch of a harmonized category hierarchy (12).

22. The apparatus (10) of claim 19, further characterized in that data indicating the harmonized category hierarchy (12) are included as part of the device (10).

23. The apparatus (10) of claim 19, further characterized in that the harmonized category hierarchy (12) is stored in a data store (12) external to the device (10) and accessible to the device (10), and the device (10) refers to the external data store (12) from time to time so as to remain harmonized to the category hierarchy (12).

24. The apparatus (10) of claim 19, further characterized in that the category indicator is a string of categories indicating a possibly partial branch of an express or implied category hierarchy (11d) of categories supported by the second device (11).

25. The apparatus (10) of claim 13, further characterized in that the apparatus is selected from the set consisting of a mobile cellular phone, a personal digital assistant type of device, a laptop computing device, and a computer.

26. A system, comprising a plurality of devices (10 11), characterized in that at least two of the devices are as in claim 13.

27. A system, comprising a plurality of devices (10 11), characterized in that at least two of the devices are as in claim 17.

28. A system, comprising a plurality of devices (10 11), characterized in that at least two of the devices are as in claim 18.

29. A system, comprising a plurality of devices (10 11), characterized in that at least two of the devices are as in claim 20.

30. A computer program product comprising: a computer readable storage structure embodying computer program code thereon for execution by a computer processor in a telecommunication terminal (10a), with said computer program code characterized in that it includes instructions for performing the steps of the method of claim 1.

31. A computer program product comprising: a computer readable storage structure embodying computer program code thereon for execution by a computer processor in a telecommunication terminal (10a), with said computer program code characterized in that it includes instructions for performing the steps of the method of claim 5.

32. A computer program product comprising: a computer readable storage structure embodying computer program code thereon for execution by a computer processor in a telecommunication terminal (10a), with said computer program code characterized in that it includes instructions for performing the steps of the method of claim 6.

33. A computer program product comprising: a computer readable storage structure embodying computer program code thereon for execution by a computer processor in a telecommunication terminal (10a), with said computer program code characterized in that it includes instructions for performing the steps of the method of claim 8.
